(19) United States
(12) Patent Application Publication
(10) Pub. No.: US 2003/0076556 A1
(43) Pub. Date: Apr. 24, 2003

(54) Optical systems and methods using selectable electro-holograms

(76) Inventors: Gregory D. VanWiggeren, Los Gatos, CA (US); Mark A. Troll, Seattle, WA (US); Tun S. Tan, Los Altos Hills, CA (US); Douglas M. Baney, Los Altos, CA (US); Jeffrey N. Miller, Los Altos Hill, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/001,315

(22) Filed: Oct. 24, 2001

(51) Int. Cl. G03H 1/00; G03H 1/02

(52) U.S. Cl. 359/3; 359/1

(57) ABSTRACT

Optical systems for selectively altering the propagation of light are provided. A representative optical system incorporates an optical device that includes a first para-electric holographic medium. The first para-electric holographic medium stores a first hologram that can exhibit a first active mode. The first hologram exhibits the first active mode when a first electric field is applied to the first para-electric holographic medium. When in the first active mode, the first hologram directs light incident upon the first holographic medium to a first location. Methods and other systems also are provided.

### BACKGROUND OF THE INVENTION

1. Field of the Invention

The present invention generally relates to optics. More specifically, the invention relates to systems and methods that use electro-holograms for selectively altering the propagation of light.

2. Description of the Related Art

Various techniques are used for altering the propagation of light. For instance, when an optical signal of an optical communication system is to be directed selectively from one component to another, a switch typically is used. Such a switch can incorporate a mirror that is arranged to receive the optical signal. By moving the mirror, the optical signal can be selectively directed among transmission media that are configured to receive optical signals from the switch. In another implementation, such a switch can be configured to move an input transmission medium, e.g., an optical fiber, so that its output end selectively aligns with one of several locations. Typically, each of the locations corresponds to an input of an optical component that is adapted to receive optical signals from the input transmission medium.

Altering the propagation of light also can include changing the focus of light. As is known, changing the focus of light oftentimes includes the use of one or more lenses. Typically, such a lens is arranged along an optical path and is moved along the optical path to change the focus of light received by the lens.

Optical systems that incorporate movable components, such as mirrors, lenses and/or transmission media, for altering the propagation of light can be problematic. In particular, alignment tolerances of the movable components can be quite small. This can make manufacture, installation and/or maintenance of the components difficult. For example, alignment of the components can change over time. This can occur due to environmental conditions, such as temperature, and/or use, e.g., moving the movable component(s) can actually cause component wear that affects the alignment. Therefore, it should be appreciated that there is a need for systems and methods that address these and/or other shortcomings of the prior art.

### SUMMARY OF THE INVENTION

Systems and methods of the invention are adapted to selectively alter the propagation of light by using optical components that can be maintained in fixed alignment relative to an optical path. In some embodiments, the optical components are maintained in fixed alignment relative to each other. In particular, selective alteration of the propagation of light can be accomplished with optical components that do not require repositioning during use. As will be described later, these systems and methods use one or more holograms, each of which can be adapted to selectively alter the propagation of light.

A representative optical system, which can alter the propagation of light without using movable optical components, incorporates an optical device that includes a first para-electric holographic medium. The first para-electric holographic medium stores a first hologram that can exhibit a first active mode. The first hologram exhibits the first active mode when a first electric field is applied to the first para-electric holographic medium. When in the first active mode, the first hologram directs light incident upon the first para-electric holographic medium to a first location. In some embodiments, the first para-electric holographic medium can be adapted to focus light to the first location.

In some embodiments, the optical device includes a second hologram that also exhibits an active mode. When the second hologram is in the active mode, light incident upon the optical device can be directed and/or focused to a second location. The second hologram can either be stored in the first para-electric holographic medium or in a second para-electric holographic medium of the optical device.

A representative method for selectively altering the propagation of light includes: providing a first para-electric holographic medium that includes a first hologram, the first hologram having a first active mode in which the first hologram directs light to a first location; propagating light to the first para-electric holographic medium; directing light to a second location with the first para-electric holographic medium; setting the first hologram to the first active mode; and, directing light to the first location with the first hologram in the first active mode, the first location being different than the second location.

By using embodiments of the invention, problems typically attributed to optical systems of the prior art can be alleviated. That is, difficulties associated with manufacture, installation and/or maintenance of the components used for altering the propagation of light can be reduced. For instance, non-moving components tend to be more robust than moving components and, therefore, may not be as likely to fail mechanically. Additionally, since the components are non-moving, attention does not need to be spent determining manufacturing tolerances associated with clearance of moving components, i.e., the tolerances associated with ensuring moving components do not improperly contact each other or non-moving components.

Various applications also can benefit from the invention. In particular, applications that involve critical alignment issues, such as the alignment of optical components in microscopy, can exhibit improved performance since the components of the optical systems of the invention typically do not require movement relative to each other. More specifically, once the components are positioned and the optical path is aligned, the components do not need to be moved in order to re-direct and/or re-focus light.

Note, certain embodiments of the invention provide other perceived advantages in addition to or in lieu of those expressly recited here. Additionally, it should be understood that various embodiments of the invention can include components that may be repositioned, such as during use.

Other systems and methods of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting a representative embodiment of an optical system of the invention.

FIG. 2 is a schematic diagram depicting a representative embodiment of an optical system of the invention.

FIG. 3 is a schematic view of a representative embodiment of an optical device that can be used to implement the optical system of FIG. 2.

FIG. 4 is a schematic view of another representative embodiment of an optical device that can be used to implement the optical system of FIG. 2.

FIG. 5 is a schematic diagram depicting another representative embodiment of an optical system of the invention.

FIG. 6 is a schematic view of a representative embodiment of an optical device that can be used to implement the optical system of FIG. 5.

FIG. 7 is a schematic view of another representative embodiment of an optical device that can be used to implement the optical system of FIG. 5.

### DETAILED DESCRIPTION

Optical systems of the invention incorporate one or more electro-holographic optical devices, each of which is adapted to selectively direct and/or focus light to one or more locations. As will be described in greater detail, some embodiments of these optical devices can selectively direct and/or focus light among various locations without the use of movable optical components, such as conventional lenses and mirrors.

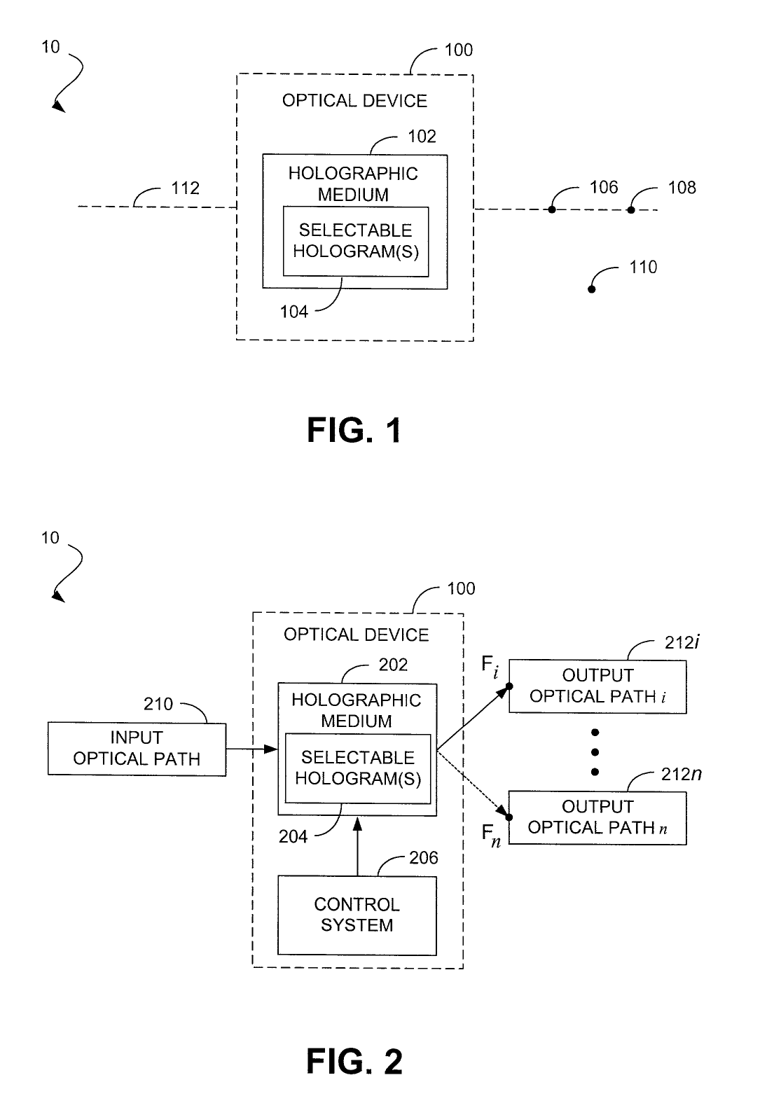

Referring now to the drawings, wherein like reference numerals indicate corresponding components throughout the several views, FIG. 1 schematically depicts a representative embodiment of an optical system 10 of the invention. Optical system 10 incorporates an optical device 100 that includes at least one para-electric holographic medium 102. Holographic medium 102 stores one or more holograms 104 that are adapted to direct and/or focus light. More specifically, such a hologram exhibits at least two modes of operation, e.g., a passive mode and an active mode. In the passive mode, the hologram typically does not affect the direction and/or focus of light propagating through the holographic medium. In the active mode, however, the hologram can direct and/or focus the light to a location other than that exhibited when the hologram is in the passive mode.

By selectively placing one or more of the holograms of the optical device in the active mode, the optical device can direct and/or focus light between various locations, e.g., locations 106, 108 and 110. As shown in FIG. 1, locations 106 and 108 are arranged along optical axis 112 of the optical device, and location 110 is arranged off of the optical axis.

FIG. 2 schematically depicts another embodiment of an optical system 10 of the invention. Optical system 10 of FIG. 2 incorporates an optical device 100 that includes at least one para-electric holographic medium 202. Holographic medium 202 stores one or more holograms 204 that are adapted to direct and/or focus light. Optical device 100 also includes a control system 206 for placing one or more of the holograms of the optical device in the active mode. In particular, the control system is able to selectively apply an electric field of a specific intensity and/or spatial orientation to holographic medium 202 so that a corresponding hologram 204 exhibits the active mode.

In embodiments of the optical device that include a single holographic medium storing multiple holograms, control system 206 can be adapted to selectively apply different electric fields to the holographic medium. Thus, a different hologram of the holographic medium can exhibit the active mode in response to the application of an associated electric field. Control system 206 can be implemented in hardware, software, firmware or a combination thereof.

Optical systems of the invention also can include one or more transmission media, e.g., optical fibers, integrated optic components or free space, that define optical paths. In the embodiment of FIG. 2, transmission media define input optical path 210 and output optical paths 212i through 212n. Input optical path 210 optically communicates with optical device 100 for propagating optical signals to the holographic medium. Output optical paths 212i through 212n also optically communicate with optical device 100. In particular, based upon the mode of one or more of the holograms 204 stored in holographic medium 202, light provided to the optical device via input optical path 210 can be selectively directed and/or focused to one of several locations, such as locations Fᵢ through Fₙ. This is accomplished by selectively placing one or more of the holograms in the active mode.

By way of example, light provided to optical device 100 via input optical path 210 can be selectively directed and/or focused to location Fᵢ by placing one or more of the holograms of holographic medium 202 in the active mode. From location Fₗ, the light then can propagate along output optical path 212i. Note that at least one of the locations Fᵢ through Fₙ is displaced from the optical axis 214 of optical device 100. This representative configuration could enable optical device 100 of FIG. 2 to function as an optical switch. For instance, if information in the form of an optical signal is intended for a destination that optically communicates with output optical path 212i, the optical device could selectively direct that optical signal to output optical path 212i. If, however, the information was intended for a destination that optically communicates with another of the output optical paths, the optical device could selectively direct the optical signal to that other output optical path. Switching optical signals between output optical paths could be accomplished at various time intervals.

Techniques such as electric-field multiplexing (EFM) can be used to store one or more holograms in a holographic medium, e.g., holographic medium 202 of FIG. 2. EFM involves applying an electric field of a particular spatial orientation and/or intensity to a holographic medium while a hologram is being written to the holographic medium. The electric field induces changes in the refractive index of the holographic medium during writing. Selective reconstruction of the hologram is achieved by applying an electric field to the holographic medium that corresponds to the electric field applied to the holographic medium when the hologram was being written.

Various materials can be used as holographic media. By way of example, a paraelectric photorefractive crystal, such as LiNbO₃, can be used. Several other representative materials that can be used are disclosed in Investigation of the Holographic Storage Capacity of Paraelectric K₁₋ₓLiₓTa_{1-y}Nb_{y}O₃:CU, V, Benny Pesach, Eli Refaeli, and Aharon, Apr. 15, 1998, Vol. 23, No.8, Optic Letters, pages 642-644; Volume Holographic Narrow-Band Optical Filter, George A. Rakuljic and Victor Layva, Optic Letters, Mar. 15, 1993, Vol. 18, No. 6, pages 459-461; Voltage-Controlled Photorefractive Effect in Paraelectric KTa₁₋ₓNbₓO₃:Cu, V, Aharon Agranat, Victor Leyva, and Amnon Yariv, Optic Letters, Sep. 15, 1989, Vol. 14, No. 18, pages 1017-1019; and Electric-Field Mutliplexing of Volume Holograms in Paraelectric Crystals, Michal Balberg, Meir Razvag, Eli Refaeli, Aharon J. Agranat, Applied Optics, Feb. 10, 1998, Vol. 37, No. 5, pages 841-847; System and Method for Modulating Light Intensity, Popovich et al., PCT Application No. PCT/US99/24250, filed on Oct. 15, 1999; and Autostereoscopic Display Based on Electrically Switchable Holograms, Popovich et al., PCT Application No. PCT/US99/15428, filed on Jul. 9, 1999. Each of the foregoing references is incorporated by reference herein.

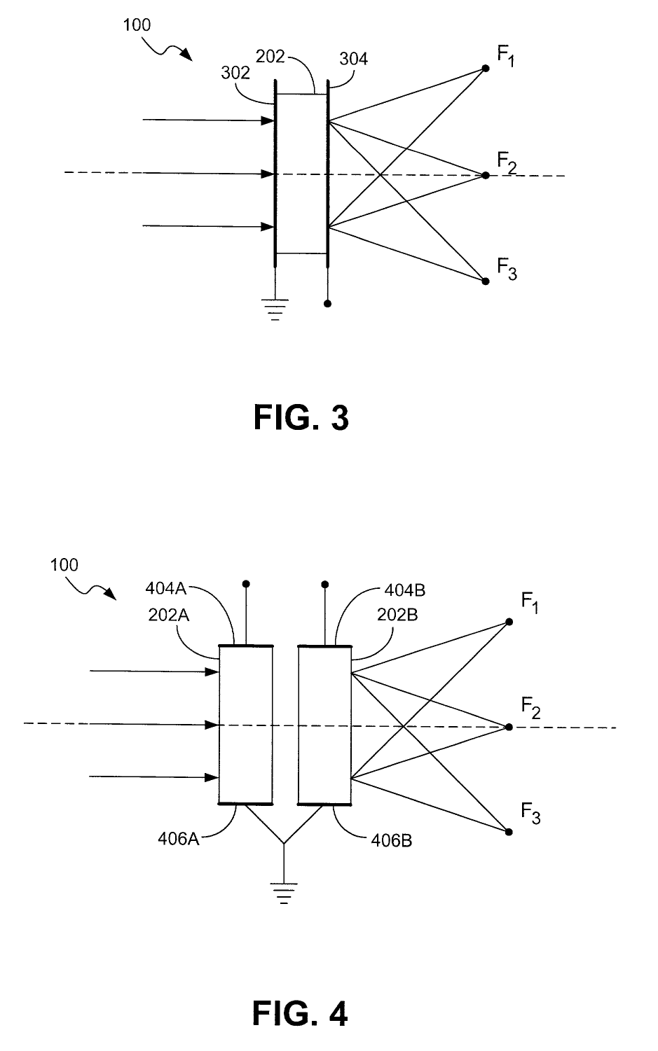

Referring now to FIG. 3, a representative embodiment of an optical device 100 that can be used in the optical system of FIG. 2 will be described. In FIG. 3, optical device 100 includes a para-electric holographic medium 202 that stores at least one hologram. In particular, holographic medium 202 defines three holograms, each of which is adapted to direct and/or focus light to different one of three locations when in an active mode. Thus, in this embodiment, each location (location F₁, F₂ or F₃) directly corresponds to a specific hologram. In other embodiments, a different number of holograms can be used. For example, light propagated through the holographic medium could be directed to location F₂ when the holograms are in a passive mode. Therefore, only two holograms could be used for selectively directing light among the three locations. More specifically, a first hologram can be used to redirect light to F₁ and a second hologram can be used to redirect light to F₃.

Holographic medium 202 is arranged between a first electrode 302 and a second electrode 304. Electrodes 302 and 304 are adapted to apply one or more electric fields across the holographic medium in order to place holograms of the medium in an active mode. Since holographic medium 202 of FIG. 3 stores multiple holograms, predetermined voltage inputs can be selectively provided to the electrodes so that an electric field of proper intensity is formed for placing a desired hologram in the active mode. The predetermined voltage inputs can be provided from a control system (not shown) that electrically communicates with the electrodes.

In FIG. 3, electrodes 302 and 304 are arranged along the optical path of optical device 100. Therefore, the electrodes should be configured so that they do not substantially prevent propagation of light through holographic medium 202. By way of example, the electrodes could be formed as layers of transparent material(s), such as thin gold film. Other arrangements of electrodes also can be used. An alternative arrangement of electrodes is depicted in the embodiment of FIG. 4.

Optical device 100 of FIG. 4 includes multiple holographic media. More specifically, the optical device includes two holographic media, i.e., holographic media 202A,202B. In other embodiments, however, more than two holographic media can be used. Each of the holographic media stores at least one hologram that can be selectively activated.

In FIG. 4, holographic medium 202A is arranged between electrodes 404A and 406A, and holographic medium 202B is arranged between electrodes 404B and 406B. Note that the electrodes are not arranged along the optical path. A control system (not shown) electrically communicates with the electrodes and is adapted to provide predetermined voltage inputs selectively to the electrodes. In this manner, an electric field of predetermined intensity can be selectively fonned across each of the holographic media for placing one or more of the holograms in the active mode. For instance, electric fields could be simultaneously applied to each of the holographic media 202A, 202B so that one hologram of each medium is placed in the active mode. In particular, when all of the holograms of the optical device are in the passive mode, light propagated by the optical device could be directed and/or focused to location F₂. A hologram of medium 202A, for example, could then be activated so that the light is directed and/or focused to location F₁. A hologram of medium 202B could then be activated so that two holograms of the optical device are in the active mode. This could direct and/or focus the light to location F₃.

As another example, the optical device 100 of FIG. 4 may place only one hologram in the active mode at a time. In such an embodiment, when all of the holograms of the optical device are in the passive mode, light propagated by the optical device could be directed and/or focused to location F₂. A hologram of medium 202A, for example, could then be activated so that the light is directed and/or focused to location F₁. The hologram-of medium 202A could then be deactivated and a hologram of medium 202B activated so that the light is directed and/or focused to location F₃.

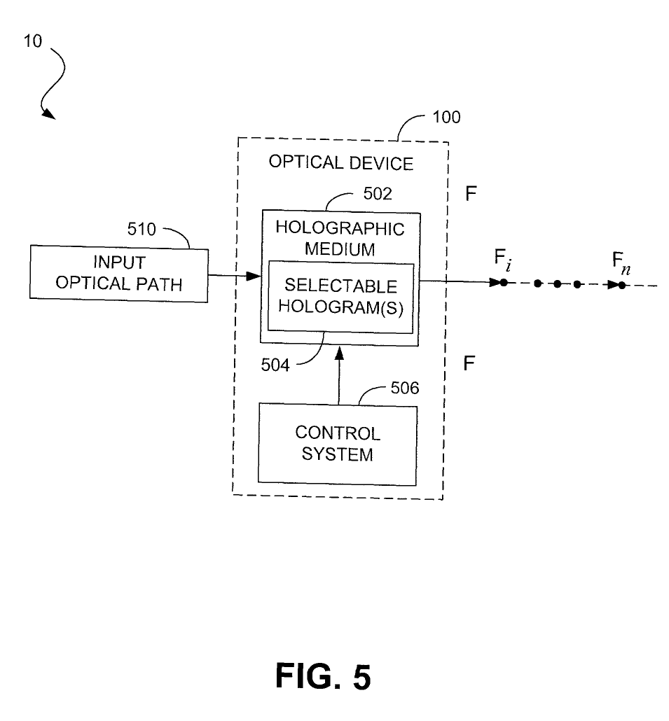

In contrast to the embodiments of FIGS. 2-4, each of which is adapted to direct and/or focus light to multiple locations that can be displaced from a respective optical axis, the embodiment of FIG. 5 is adapted to direct and/or focus light to multiple locations arranged along the optical axis. In particular, optical device 100 of FIG. 5 can selectively direct and/or focus light to one of locations Fi through Fn, at least some of which are arranged along the optical axis.

As shown in FIG. 5, optical device 100 includes a para-electric holographic medium 502. Holographic medium 502 stores at least one hologram 504 that is adapted to direct and/or focus light. Optical device 100 also includes a control system 506 for placing one or more of the holograms of the optical device in the active mode. In particular, the control system is able to selectively apply an electric field of a specific intensity and/or spatial orientation to holographic medium 502 so that a corresponding hologram 504 exhibits the active mode. Much like control system 206 of FIG. 2, control system 506 can be implemented in hardware, software, firmware or a combination thereof.

By placing one or more of the holograms 504 in the active mode, light provided to the optical device 100 via input optical path 510 can be focused among locations Fᵢ, through Fₙ, which are arranged along the optical axis of the optical device. Note, in other embodiments, one or more of the locations of focus may be arranged at other locations, i.e., locations off of the optical axis.

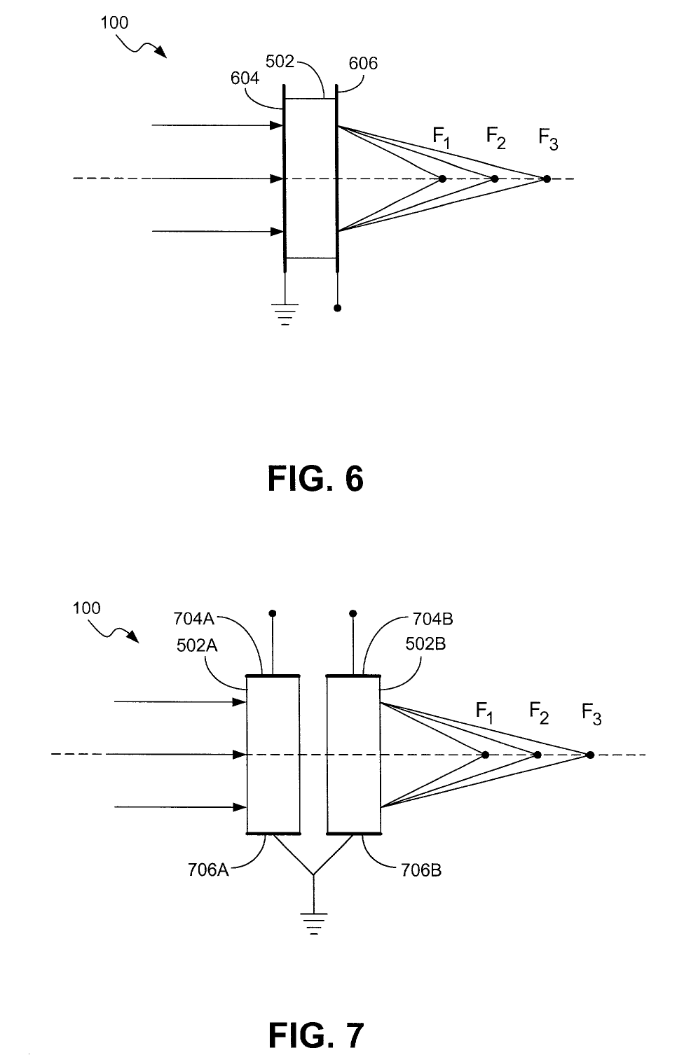

The optical device 100 of FIG. 5 can be used in various applications. By way of example, such an optical device may be well suited for use in the fields of telescopy and/or microscopy, for example. Of particular interest is the ability of the optical device of FIG. 5 to focus light at different locations along the optical axis without moving and/or changing the alignment of components of the optical device. A representative embodiment of an optical device 100 that can be used in the optical system 10 of FIG. 5 is depicted schematically in FIG. 6.

As shown in FIG. 6, optical device 100 includes a holographic medium 502 that stores at least one selectable hologram. In particular, holographic medium 502 defines three holograms, each of which is adapted to focus light to different one of three locations when in an active mode. In this embodiment, each location (location F₁, F₂ or F₃) directly corresponds to a specific hologram. However, in other embodiments, such as described in relation to the optical device of FIG. 3, a different number of holograms can be used.

Holographic medium 502 is arranged between a first electrode 604 and a second electrode 606. Electrodes 604 and 606 are adapted to apply one or more electric fields across the holographic medium in order to place holograms of the medium in an active mode. Predetermined voltage inputs can be selectively provided to the electrodes by a control system (not shown) so that an electric field of proper intensity is formed for placing a desired hologram in the active mode.

Optical device 100 of FIG. 6 selectively focuses light to one of locations F₁, F₂ or F₃. For instance, when a first hologram of holographic medium 502 is active and others of the holograms are passive, the first hologram focuses the light to position F₁. When a second hologram is active and others of the holograms are passive, the light is focused to position F₂. Moreover, when a third hologram is active and others of the holograms are passive, the light is focused to position F₃.

Another representative embodiment of an optical device 100 that can change the focus of light along an optical axis is depicted schematically in FIG. 7. As shown in FIG. 7, optical device 100 includes multiple holographic media, i.e., holographic media 502A,502B. Each of the holographic media stores at least one hologram that can be selectively activated. Electrodes 704A and 706A, and 704B and 706B engage holographic media 502A and 502B, respectively. The electrodes receive predetermined voltage inputs from a control system (not shown) so that an electric field of predetermined intensity can be selectively formed across each of the holographic media. For instance, electric fields could be simultaneously applied to each of the holographic media 502A, 502B so that one hologram of each medium is placed in the active mode. In other embodiments, only one hologram may be placed in the active mode at a time.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated.

By way of example, the embodiments depicted herein direct and/or focus light at locations downstream of the optical device; however, one or more directions and/or locations of focus upstream of the optical device may be provided. In some of these embodiments, beams of light output from the device may be received as substantially parallel beams, for example, and may be output as divergent beams.

Also note that holograms used in optical devices of the invention can be constructed to receive inputs and provide outputs of unequal numbers. For instance, a particular hologram could be used to split an input optical signal into multiple output optical signals. Additionally, such a hologram could direct and/or focus each of the output signals to a different location, as desired.

All such modifications and variations are within the scope of the invention as determined by the appended claims when interpreted in accordance with the breadth to which they are fairly and legally entitled.

1. An optical system comprising:
an optical device including a first para-electric holographic medium, said first holographic medium storing a first hologram, said first hologram having a first active mode, said first hologram exhibiting said first active mode when a first electric field is applied to said first holographic medium, in said first active mode said first hologram being adapted to direct light incident upon said first para-electric holographic medium to a first location.

2. The optical system of claim 1, wherein said optical device is adapted to selectively direct light between said first location and a second location such that said optical device operates as a switch.

3. The optical system of claim 1, wherein in said first active mode said first hologram is adapted to focus light incident upon said first para-electric holographic medium to said first location.

4. The optical system of claim 1, wherein said first location is arranged along an optical axis of said optical device; and
wherein said optical device includes a second hologram, said second hologram having a second active mode, said second hologram exhibiting said second active mode in response to a second electric field, in said second active mode said second hologram being adapted to focus light incident upon said optical device to a second location, said second location being arranged along the optical axis of said optical device.

5. The optical system of claim 1, further comprising:
a first electrode arranged proximate to said first para-electric holographic medium;
a second electrode arranged proximate to said first para-electric holographic medium; and
a control system electrically communicating with said first electrode and said second electrode, said control system being adapted to apply an electric potential across said first electrode and said second electrode to generate said first electric field.

6. The optical system of claim 1, further comprising:
means for applying said first electric field across said first para-electric holographic medium.

7. The optical system of claim 1, wherein said optical device includes a second hologram, said second hologram having a second active mode, said second hologram exhibiting said second active mode in response to a second electric field, in said second active mode said second hologram being adapted to direct light incident upon said optical device to a second location.

8. The optical system of claim 7, wherein said optical device includes a second para-electric hologra phic medium, said second holographic medium storing said second hologram.

9. The optical system of claim 7, wherein said first para-electric holographic medium stores said second hologram.

10. The optical system of claim 7, further comprising:
a first output transmission medium optically communicating with said optical device, said first output transmission medium being adapted to receive at least some of the light propagated to said first location; and
a second output transmission medium optically communicating with said optical device, said second output transmission medium being adapted to receive at least some of the light propagated to said second location.

11. The optical system of claim 10, further comprising:
a first input transmission medium optically communicating with said optical device, said first input transmission medium being adapted to propagate light to said optical device.

12. A method for selectively altering the propagation of light comprising:
providing a first para-electric holographic medium, the first para-electric holographic medium including a first hologram, the first hologram having a first active mode, in the first active mode the first hologram being adapted to direct light to a first location;
propagating light to the first para-electric holographic medium;
directing light to a second location with the first para-electric holographic medium;
setting the first hologram to the first active mode; and
directing light to the first location with the first hologram in the first active mode, the first location being different than the second location.

13. The method of claim 12, wherein the first para-electric holographic medium includes a second hologram, the second hologram having a second active mode, in the second active mode the second hologram being adapted to direct light to the second location; and
wherein directing light to a second location includes:
setting the second hologram to the second active mode; and
directing light to the second location with the second hologram in the second active mode.

14. The method of claim 12, wherein directing light to the first location includes focusing light to the first location.

15. The method of claim 12, wherein the first and second locations are arranged along an optical axis of the first para-electric holographic medium.

16. The method of claim 15, wherein directing light to the first location comprises:
focusing light to the first location; and
wherein directing light to the second location comprises:
focusing light to the second location.

17. The method of claim 15, wherein setting the first hologram to the first active mode comprises:
applying a first electric field across the first para-electric holographic medium.

18. The method of claim 15, further comprising:
providing a second para-electric holographic medium, the second para-electric holographic medium including a second hologram, the second hologram having a second active mode, in the second active mode the second hologram being adapted to direct light to a third location;
propagating light to the second para-electric holographic medium;
directing light to the first location with the second para-electric holographic medium;
setting the second hologram to the second active mode; and
directing light to the third location with the second hologram in the first active mode, the third location being different than the second location.

19. The method of claim 18, wherein setting the second hologram to the second active mode comprises:
setting the first hologram to the first active mode.

20. The method of claim 12, wherein the first para-electric holographic medium optically communicates with a first output transmission medium and a second output transmission medium; and
further comprising:
receiving at least some of the light propagated to the first location with the first output transmission medium; and
receiving at least some of the light propagated to the second location with the second output transmission medium.
